(19) United States
(12) Patent Application Publication
(10) Pub. No.: US 2021/0278256 A1
(43) Pub. Date: Sep. 9, 2021

(54) Displacement Sensor Device

(71) Applicant: Maskinteknik I Oskarshamn AB, Oskarshamn (SE)

(72) Inventors: Urpo Pehkonen, Ruda (SE); Juha Pehkonen, Oskarshamn (SE)

(73) Assignee: Maskinteknik I Oskarshamn AB, Oskarshamn (SE)

(21) Appl. No.: 16/321,449

(22) PCT Filed: Jul. 6, 2017
(86) PCT No.: PCT/SE2017/050760

§ 371 Date: Jan. 28, 2019

(30) Foreign Application Priority Data
Jul. 29, 2016 (SE) 1651089-3

(51) Int. Cl. G01D 5/353; G01L 1/24; G01D 11/18; G01D 11/24

(52) U.S. Cl. CPC G01D 5/35316; G01D 11/24; G01D 11/18; G01L 1/246

(57) ABSTRACT

A displacement sensor device (1) comprising a fibre bragg grating sensor (2) and a downshift unit (3). The downshift unit (3) is connected to the fibre bragg grating sensor (2), a first (4) and a second fastening device (5). The first fastening device (4) is connected to the downshift unit (3), and the second fastening device (5) is connected to the fibre bragg grating sensor (2), a container (6) enclosing the fibre bragg grating sensor (2), the downshift unit (3), at least partially the first (4) and the second fastening device (5), and at least partially an optical fibre (7). Furthermore the sensor device (1) comprises at least one fixing component (8). The at least one fixing component (8) is arranged between one of the fastening devices (4, 5) and the container (6).

### TECHNICAL FIELD

The present invention relates to a displacement sensor device.

### BACKGROUND ART

A displacement sensor device is normally a mechanical or optical device which is placed in or onto bedrock, bridges, houses or other infrastructure projects. A displacement sensor device comprises an optical fibre for sensing displacements in the surrounding environment where the displacement sensor device is fastened.

A displacement is here defined as a change in distance (distance: L, change in distance: ΔL) between two fixing points A and B. The displacement sensor device is fastened in point A and B.

The optical fibre is affected by displacements in the material to measure, such as bedrock and different type of infrastructure projects. The displacement sensor device measures a potential displacement between two fixing points. A displacement could be a result of natural or man-made causes.

A displacement sensor device may comprise a Fibre Bragg Grating, which is a type of distributed Bragg reflector. The FBG could be an important component in order to measure the strains in an optical fibre caused by the displacements between the two fixing points.

A displacement sensor device may comprise a downshift unit downshifting the displacements which the FBG is affected by from the surrounding environment when installed. Downshifting is necessary in order for the FBG not to be damaged and for the device to be able to measure in a predefined measurement interval.

A displacement sensor device may comprise a container for protecting the device from the environment. Water and particles from the surrounding environment could otherwise damage the device when installed at site.

A displacement sensor device may have fastening devices for transferring the displacements to be measured to the downshifting unit and the FBG.

A displacement sensor device may have an optical fibre for communication between the device and additional components in a displacement sensor system.

In certain cases, the user of displacement sensor devices and displacement sensor systems would like to be able to measure displacements in bedrock or infrastructure projects in locations where it is not possible to adjust the settings of the displacement sensor device during installation or after it is installed. Examples of such locations, are drilled holes in the bedrock and/or the infrastructure project. These drilled holes could be 3-4 cm in diameter, but the diameter could also be smaller and greater. The displacement sensor device is normally otherwise, when it is possible to physically reach the device after the device has been installed at site, adjusted by mechanically adjusting the downshift unit or adjusting other parts of the device. After the manufacturing of a displacement sensor device the adjustment of the device may be altered while in transit or during installation due to external mechanical forces affecting the device. Normally a displacement sensor device thus has to be adjusted during or after installation. If the device is not properly adjusted, the device will not provide correct measurements to the user. This implies that the user will not know if or by how much the bedrock or infrastructure projects has been affected by displacements.

In certain cases, the user of displacement sensor devices would furthermore like to be able to use a device which covers a certain number of known or unknown existing or potential crack formations or deformations. These formations could be spread over a certain area in the bedrock or infrastructure project.

In certain cases the user of displacement sensor devices would furthermore like to be able to connect several displacement sensor devices in series in narrow surroundings, for instance several devices in series in one or in several drilled holes with a limited diameter, delivering continuous series of measurements with high accuracy and over a long period of time.

### SUMMARY OF THE INVENTION

An object of the present invention is thus to accomplish a displacement sensor device which:
a) does not have to be adjusted during or after installation
b) could be adjusted in length or being extended
c) could be installed in series in narrow surroundings, for instance several devices in series in one or in several drilled holes with a limited diameter, delivering continuous series of measurements with high accuracy and over a long period of time.

According to one aspect, the invention concerns a displacement sensor device comprising a fibre bragg grating sensor for sensing displacements in the surrounding environment where the displacement sensor device is fastened, a downshift unit for downshifting the displacements towards the fibre bragg grating sensor which the displacement sensor device is affected by when installed. Wherein the downshift unit is connected to the fibre bragg grating sensor. Further a first and a second fastening device for fastening of the displacement sensor device in the surrounding environment. Wherein the first fastening device is connected to the downshift unit, and the second fastening device is connected to the fibre bragg grating sensor. Further a container enclosing the fibre bragg grating sensor, the downshift unit, at least partially the first and the second fastening device, and at least partially the optical fibre. The device is characterised in that the sensor device comprises at least one fixing component, for holding the fastening devices in position so that a predefined distance between the fastening devices is fixed. Wherein the at least one fixing component is arranged between one of the fastening devices and the container. Further wherein the at least one fixing component is arranged to break or deform when a force applied to the displacement sensor device is greater than a predefined value.

An advantage with the solution, is having the displacement sensor device positioned in narrow surroundings, for instance several devices in series in one or several drilled holes with a limited diameter, can deliver continuous series of measurements with high accuracy and over a long period of time. This is not possible to achieve by using existing solutions. Further, the measurement of potential movements in the material to be monitored can be conducted in real time. Furthermore, the downshift unit is integrated in the displacement sensor device, which itself is incorporated in a container and is therefore protected from the external environment, where physical stress, water and particles otherwise could affect the device. Further, the at least one fixing component prevent the calibration of the displacement sensor device from being altered during transportation and installation. Furthermore, the calibration of the downshift unit means that the predefined position of the downshift unit and thus the whole displacement sensor device is set. Setting the predefined position of the downshift unit can for instance imply that the displacement sensor device is set in the middle of the predefined measurement interval, or in one end of the predefined measurement interval (maximum or minimum). The predefined position of the downshift unit and thus the whole displacement sensor is further protected by the at least one fixing component when the displacement sensor device is in transit or during installation at site. Further, the length of the downshift unit can be altered, and additional to this the length of the container. This means that the displacement sensor device could cover a certain number of known or unknown existing or potential crack formations or deformations as the length of the displacement sensor device can be altered to a suitable length. The crack formations or deformations could be spread over a certain area in the bedrock or infrastructure project. Furthermore, as the at least one fixing component is arranged to break or deform when a force applied to the displacement sensor device is greater than a predefined value, implies that the displacement sensor device will after installation start reacting on external forces which are greater than the predefined value. It also implies that, the starting point in the predefined measurement interval does not need to be adjusted/tuned during or after installation, as the FBG will be protected from external forces from production to after installation on site. Further, the at least one fixing component provides a fixing function preventing the calibration of the displacement sensor device of being damaged during transportation and installation. The at least one fixing component will not be easily activated when the displacement sensor device is transported or installed at site. However, the at least one fixing component will easily be activated when affected by a displacement after the displacement sensor device has been installed. This is because the potential external forces applied on the at least one fixing component are much greater when the displacement sensor device is installed during a displacement than during transportation or installation.

The above system may be configured according to different optional embodiments. For example, wherein the at least one fixing component may be fabricated out of a brittle material, for instance a polymer.

An advantage with the solution is that, as the at least one fixing component may be arranged to be deformed when a force applied to the displacement sensor device is greater than a predefined value, the displacement sensor device will after installation start reacting on external forces which are greater than the predefined value. It also implies that the adjustment of the displacement sensor device will be protected from external forces from production to after installation on site.

According to an embodiment of the invention, wherein the container or the first ( ) and/or the second fastening device may comprise at least one fixing component.

An advantage with the solution is that, if the container or the first and/or the second fastening device comprises at least one fixing component, the number of components needed for the described displacement sensor device will be fewer, the cost of production of the device might be lower, the production and the adjustment of the device might be faster, and the structural strength of the device might be greater.

According to an embodiment of the invention, wherein the downshift unit may comprise a draw spring and a drag link. Wherein a longitudinal end portion of the draw spring may be connected to a longitudinal end portion of the drag link.

An advantage with the solution is that pre calibration of the displacement sensor device without the need to re-calibrate the device at the installation site is made possible. The pre calibration could for instance be conducted at the production plant. Further, the combination of using a draw spring and a drag link for a downshift unit provides a possibility to a simple, precise and robust pre-calibration of the displacement sensor device. Furthermore, the combination of using a draw spring and a drag link for a downshift unit makes it easier to separate the downshift unit from the optical cable, ensuring that movements of the optical cable do not affect the downshift unit and/or the FBG. These movements could otherwise cause the FBG to strain, and subsequently to give false outputs.

According to an embodiment of the invention, the device may comprise a draw spring matching a predefined measurement interval of the displacement sensor device. The draw spring belonging to a plurality of draw springs with different spring rates.

An advantage with the solution is that it makes it easy to choose a suitable predefined measurement interval for each displacement sensor device. Different draw springs match different predefined measurement intervals. This is due to the fact that different draw springs have different spring rates. Using industrially manufactured and tested draw springs makes it easy to choose a suitable predefined measurement interval for each displacement sensor device.

According to an embodiment of the invention, wherein the container may be made out of a solid material, for instance a metal, a polymer or a carbon fibre, withstanding a predefined force.

An advantage with the solution is that the device is less sensitive to physical stress as the construction is more robust as the container can be made out of a metal material, for instance steel. The container could then prevent the rest of the displacement sensor device from being damaged for instance by vibrations from shaped explosive charges, by vibrations from heavy vehicles working in or on the bedrock/infrastructure, by variations in temperature, and by water in the bedrock/infrastructure, among others.

According to an embodiment of the invention, the device may comprise at least one communication channel connected to the fibre bragg grating sensor. Wherein the communication channel provides communication to/from the displacement sensor device.

An advantage with the solution is that a communication channel will provide communication to/from the displacement sensor device. The communication channel could, among others, be an optical fibre, wherein the optical fibre is connected to the fibre bragg sensor. Further, by using an optical fibre for the transfer of signals, the system will not be affected by electromagnetic fields, and the loss of data over long distances will be negligible.

According to an embodiment of the invention, the device may comprise at least one protection component arranged in between the container and the first fastening device and/or in between the container and the second fastening device for protecting the internal components of the downshift unit from the external environment.

An advantage with the solution is that a protection component will protect the internal components of the downshift unit from various hazards found in the external environment. The external environment could for instance expose the downshift unit to water, other liquids, humidity, dirt and debris.

According to an embodiment of the invention, the device may comprise at least one fastening device connected to an extension unit or to a plurality of extension units connected in series, for extension to another displacement sensor device or to an extension fastening device or to a plurality of extension fastening devices connected in series.

An advantage with the solution is that at least one of the fastening devices of the displacement sensor device may have an extension unit. The length of the displacement sensor device may therefore be elongated after manufacturing by connecting an extension fastening device to the fastening device with the extension unit. The displacement sensor device with a fastening device comprising an extension unit may also be directly connected to another displacement sensor device with a fastening device possibly comprising an extension unit. These extension units and extension fastening devices extend the distance (L) between the two fixing points (A, B). As a result a longer distance, and thus a larger area of the bedrock or infrastructure project, may be measured. These components may be important if for instance further cracks or deformations have been identified or if at least one of the fastening points in the bedrock or infrastructure project do not provide a solid section for fastening of the displacement sensor device. It is however important to emphasize that the calibrated starting point in the predefined measurement interval of any of the displacement sensor devices which are put together will remain intact/will not be affected by the elongation procedure described. The displacement sensor device with the described components above implies that a displacement sensor device might connect directly with another displacement sensor device, with an extension unit in between the devices, or connect with another displacement sensor device further away via a communication channel, or be the last sensor in an installation, or connect with an extension fastening device comprising an extension unit so that the distance to a fixing point is extended, or connect to other measurement devices via a communication channel.

According to one aspect, the invention concerns a displacement sensor system comprising a plurality of displacement sensor devices connected in series.

An advantage with the solution is that, by that the displacement sensor system comprising a plurality of displacement sensor devices, the displacement sensor system can ideally be connected to additional equipment. Each individual displacement sensor device can thus be tailored to specific requirements regarding the magnitude of the displacements to be detected. Further, a plurality of sensor devices can form a long sensor, which for instance can be installed where there are physical limitations, such as narrow passages etc. The displacement sensor system will also be suitable for areas to be monitored which are not fully following a straight line, as the displacement sensor devices connected together can form different types of shapes, such as curved shaped lines among others. Furthermore, sectioning of measurements can be achieved. This means that certain sections of the bedrock or infrastructure can comprise one or several displacement sensor devices. For instance could one section which is five metre long comprise five different displacement sensor devices, and other section which is 15 metre long could comprise three different displacement sensor devices.

The predefined value is chosen to be greater than, what the ordinary forces which could affect the displacement sensor device during transportation and installation could be, and when the fixing component is arranged to break the chosen material of the fixing component is subsequently chosen to be strong enough to withstand these forces.

The predefined value is chosen to be lower than, what the forces which are interesting for the displacement sensor device to measure after installation could be, and when the fixing component is arranged to break the chosen material of the fixing component is subsequently chosen to be weak enough not to withstand these forces.

The at least one fixing component could for instance be ring shaped and at least encircle the fastening devices. The at least one fixing component could be made out of a polymer. The at least one fixing component could also consist of metal pins, wires, a combination of balls with springs, adhesive, among others.

The at least one fixing component can be only one, and arranged between any of the fastening devices and a corresponding end portion of the container. Preferably there are several fixing components, positioned both in between the first fastening device and the corresponding end portion of the container and the second fastening device and the corresponding end portion of the container.

The fastening devices of the displacement sensor device can for instance be glued, bolted or cemented, among other techniques, into or onto the material which is to be measured.

If the fastening devices are glued or cemented into or onto the material which is to be measured, a technique where the glue or the cement is spread into the for instance drilled holes may be used. If a rifled material is used for the fastening devices, the glue or cement will then flow into the recesses of the rifled material before drying.

The fastening devices are in one perspective part of the protective cover of the displacement sensor device, and where the container and the at least one fixing component is another part of the protective cover.

The fastening devices can be made out of different types of massive materials, they could also be rifled, they could also comprise means of attachment, they could also be made out of stainless steel, they could also have drillings for the optical fibre.

The length of the displacement sensor device may be manufactured according to a predetermined length between the first and the second fastening device. The device may be calibrated before installation, i.e. at the manufacturing plant, to ensure a predefined starting point within the measurement interval.

The predefined value is chosen to be greater than, what the ordinary forces which could affect the displacement sensor device during transportation and installation could be, and subsequently the chosen material of the fixing component to be static enough to withstand these forces.

The predefined value is chosen to be lower than, what the forces which are interesting for the displacement sensor device to measure after installation could be, and subsequently the chosen material of the fixing component to be flexible enough not to withstand these forces.

The drag link is needed in order to achieve a certain length between the fastening devices and the fibre bragg grating sensor, and for the downshift unit to be securely fastened to the fastening device.

The downshift unit could also be constructed by using a thread and a nut with a cable wheel. The predefined measurement interval would then be adjusted by altering the gradient of the thread or changing the diameter of the cable wheel. Other types of mechanical downshift could also be used.

The inlet and the outlet channels in the displacement sensor device for the communication channel are arranged so that the displacement sensor device is water proof.

The protection component can for instance be o-rings among others.

The pre-fabricated fibre bragg grating sensor often includes an elastic structure.

Strain sensors in general and discrete FBG sensors can be used in the μm-sub-mm interval. In order for the displacement sensor device to detect greater displacements, the illustrated displacement sensor device comprises a downshift unit with a draw spring and a drag link. In choosing a draw spring among a plurality of different draw springs with different spring rates, each individual displacement sensor device can be tailored to specific requirements regarding the magnitude of the displacements to be detected, for instance displacements in the cm or in the m interval.

Calibration screws may be used in connection with springs.

The developed displacement sensor device and its downshift unit has been tested at an independent research institute and the results have illustrated that the displacement sensor device responds with good accuracy.

The bandwidth used in a displacement sensor device is decreased the greater the downshift is. How the bandwidth is allocated to each displacement sensor device is of importance, as this determines how many displacement sensor devices can be integrated to a single fibre connected to the additional equipment.

Fibre Bragg grating (FBG) sensors are well known in the optical sensors industry. The compression and/or strain on an optical fibre will be detected by using these FBG sensors.

For the measurements of the displacement sensor device not to be affected by variations in temperature, the temperature has to be measured and accounted for. There are standard formulas, well known in the industry, accounting and adjusting for the measured temperatures. There could be temperature sensors in one or a plurality of the displacement sensor devices.

A fibre bragg grating sensor can have different levels of resolution, from low to high.

Fibre bragg gratings in optical fibres can be made by exposing an area of the fibre with ultraviolet or femtosecond laser, and by doing so a periodic refractive index can be created along a certain region of the fibre. The periodic refractive index will act as a wavelength dependent reflector. The reflected wavelength is dependent on strain, and temperature, and by measuring the reflected wavelength these entities can thus be monitored.

The displacement sensor device which initially has been produced has been incorporated in a steel tube, which is about one metre long and 28 mm in diameter. However, the length and the diameter of the steel tube can easily be altered to other dimension. Also the material can be changed to other possibly more suitable materials.

The following two predefined measurement intervals have so far been tested for the displacement sensor device and for additional connected equipment. Measurement interval: 0-10 mm/m of fibre with a resolution of 100.0 μm/m. Measurement interval: ±2000 μm/m of fibre with a resolution of 1.0 μm/m. The first mentioned interval is for instance suitable for measurements close to the surface of the bedrock. The last mentioned interval is for instance suitable for measurements deeper down in the bedrock, as potential movements there are often smaller than movements closer to the surface of the bedrock. The displacement sensor device is however not limited to the above mentioned intervals.

The displacement sensor device can be used in the mining industry, but also in the construction industry, in surveillance and monitoring of dams and bridges and in other infrastructure projects.

Existing constructions over and under the surface of the soil can be monitored by the described displacement sensor device and the displacement sensor system. This implies that excavations can be made and new constructions under the surface can be undertaken, while monitoring the existing constructions.

The displacement sensor device and the displacement sensor system can ideally be used in monitoring repositories in the bedrock for spent nuclear fuel and nuclear power plant waste. These types of constructions have very strict requirements regarding documentation. This also implies that systems gathering data concerning potential movements in the bedrock should be built for harsh environments and last a long time. The described displacement sensor device and system will fulfil these very strict requirements.

The displacement sensor device is suitable for providing measurements in bedrock, and into or onto infrastructure projects such as bridges, buildings, among others.

The optical circulator separates optical signals from each other. This could for instance be separating emitted light from reflected light.

### BRIEF DESCRIPTION OF DRAWINGS

The invention is now described, by way of example, with reference to the accompanying drawings, in which:

FIG. 1 is a block diagram illustrating, according to an embodiment of the invention, and

FIG. 2 shows a displacement sensor device in a cutaway front view, according to an embodiment of the invention, and

FIG. 3 shows two displacement sensor devices in a front view, according to an embodiment of the invention, and

FIG. 4 shows a displacement sensor device in a front view, according to an embodiment of the invention, and

### DESCRIPTION OF EMBODIMENTS

In the following, a detailed description of a displacement sensor device is provided.

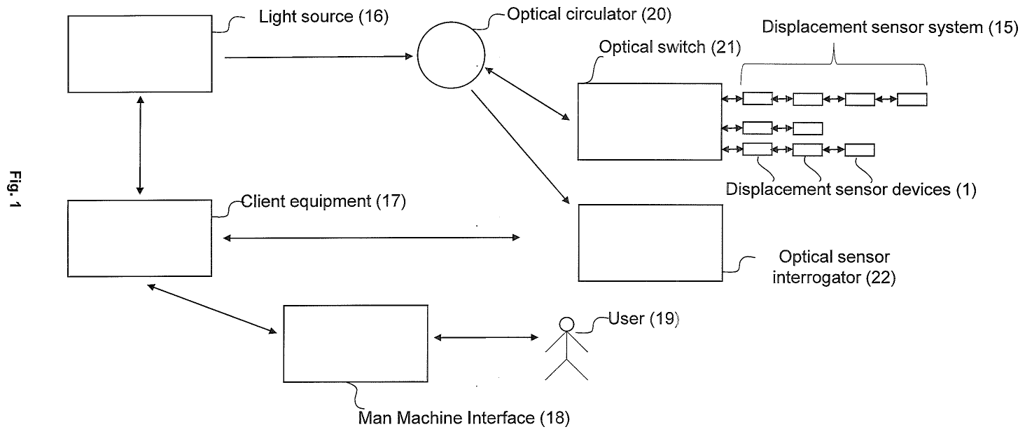

FIG. 1 shows a light source 16, an optical circulator 20, an optical switch 21, an optical sensor interrogator 22, a client equipment 17, a Man Machine Interface 18, a user 19, a plurality of displacement sensor devices 1, and a displacement sensor system 15. FIG. 1. Illustrates how at least one displacement sensor device 1 may be connected to additional equipment.

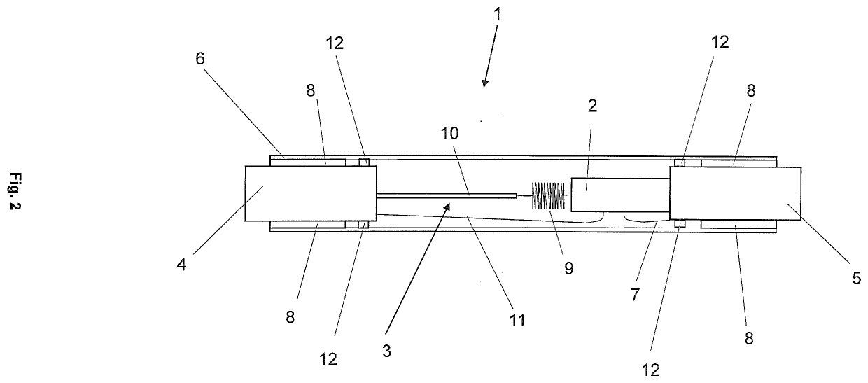

FIG. 2 shows a displacement sensor device 1 in a cutaway front view, according to an embodiment of the invention. The displacement sensor device 1 comprising a fibre bragg grating sensor 2, a downshift unit 3 comprising a draw spring 9 and a drag link 10, a first 4 and a second fastening device 5, a container 6, an optical fibre 7, at least one fixing component 8, at least one communication channel 11, and at least one protection component 12.

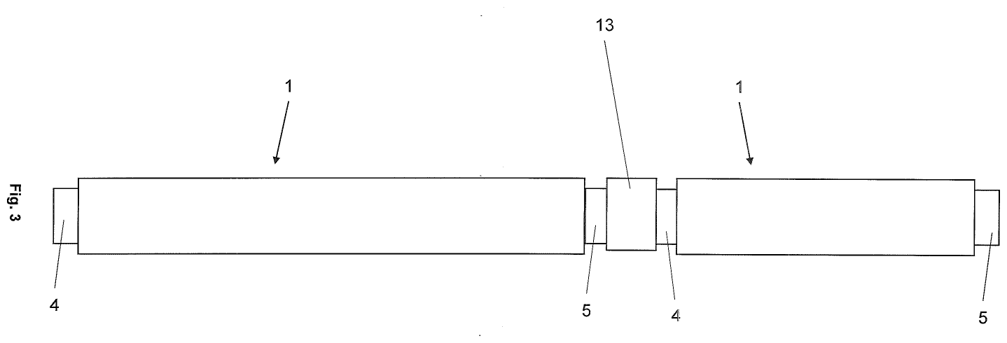

FIG. 3 shows two displacement sensor devices 1 in a front view, according to an embodiment of the invention. One of the displacement sensor devices 1 comprises a first 4 and a second fastening device 5, and the other displacement sensor device 1 comprises another first 4 and another second fastening device 5. An extension unit 13 is connecting one of the first fastening devices 4 to one of the second fastening devices 5, resulting in the two displacement sensor devices 1 being connected in series.

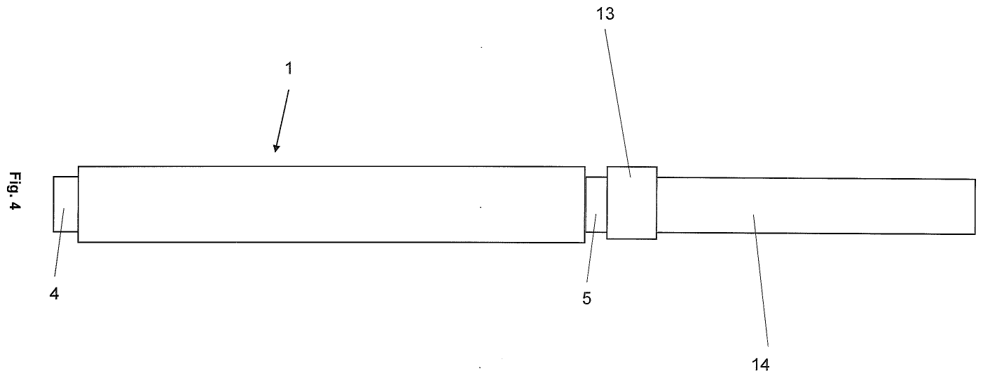

FIG. 4. Shows a displacement sensor device 1 in a front view, according to an embodiment of the invention. The displacement sensor device 1 comprises a first 4 and a second fastening device 5. The second fastening device 5 is connected to an extension unit 13. The extension unit 13 is connected to an extension fastening device 14.

1. A displacement sensor device (1) comprising
a fibre bragg grating sensor (2) for sensing displacements in the surrounding environment where the displacement sensor device (1) is fastened,
a downshift unit (3) for downshifting the displacements towards the fibre bragg grating sensor (2) which the displacement sensor device (1) is affected by when installed, wherein the downshift unit (3) is connected to the fibre bragg grating sensor (2),
a first (4) and a second fastening device (5) for fastening of the displacement sensor device (1) in the surrounding environment, wherein the first fastening device (4) is connected to the downshift unit (3), and the second fastening device (5) is connected to the fibre bragg grating sensor (2),
a container (6) enclosing the fibre bragg grating sensor (2), the downshift unit (3), at least partially the first (4) and the second fastening device (5), and at least partially an optical fibre (7),
characterised in that the sensor device (1) comprises
at least one fixing component (8), for holding the fastening devices (4, 5) in position so that a predefined distance between the fastening devices (4, 5) is fixed, wherein the at least one fixing component (8) is arranged between one of the fastening devices (4, 5) and the container (6), further wherein the at least one fixing component (8) is arranged to break or deform when a force applied to the displacement sensor device (1) is greater than a predefined value.

2. A displacement sensor device (1) according to claim 1, wherein the at least one fixing component (8) is fabricated out of a brittle material, for instance a polymer.

3. A displacement sensor device (1) according to claim 1-2, wherein the container (6) or the first (4) and/or the second fastening device (5) comprises at least one fixing component (8).

4. A displacement sensor device (1) according to claim 1-3, wherein the downshift unit (3) comprises a draw spring (9) and a drag link (10), wherein a longitudinal end portion of the draw spring (9) is connected to a longitudinal end portion of the drag link (10).

5. A displacement sensor device (1) according to claim 1-4, comprising a draw spring (9) matching a predefined measurement interval of the displacement sensor device (1), the draw spring (9) belonging to a plurality of draw springs (9) with different spring rates.

6. A displacement sensor device (1) according to claim 1-5, wherein the container (6) is made out of a solid material, for instance a metal, a polymer or a carbon fibre, withstanding a predefined force.

7. A displacement sensor device (1) according to claim 1-6, comprising at least one communication channel (11) connected to the fibre bragg grating sensor (2), wherein the communication channel (11) provides communication to/from the displacement sensor device (1).

8. A displacement sensor device (1) according to claim 1-7, comprising at least one protection component (12) arranged in between the container (6) and the first fastening device (4) and/or in between the container (6) and the second fastening device (5) for protecting the internal components of the downshift unit (3) from the external environment.

9. A displacement sensor device (1) according to claim 1-8, comprising at least one fastening device (4, 5) connected to an extension unit (13) or to a plurality of extension units (13) connected in series, for extension to another displacement sensor device (1) or to an extension fastening device (14) or to a plurality of extension fastening devices (14) connected in series.

10. A displacement sensor system (15) according to any of the claims 1-9, comprising a plurality of displacement sensor devices (1) connected in series.
